(19) United States
(12) Patent Application Publication
(10) Pub. No.: US 2023/0255176 A1
(43) Pub. Date: Aug. 17, 2023

(54) ANIMAL HOUSING DEVICE

(71) Applicant: Anna Neuenschwander, Auburn, NY (US)

(72) Inventor: Anna Neuenschwander, Auburn, NY (US)

(21) Appl. No.: 18/110,477

(22) Filed: Feb. 16, 2023

Related U.S. Application Data
(60) Provisional application No. 63/311,076, filed on Feb. 17, 2022.

(51) Int. Cl. A01K 1/035

(52) U.S. Cl. CPC A01K 1/035

(57) ABSTRACT

A housing for an animal having a toroidal body defining an annular chamber therein. One or more openings are formed in the body and permit communication with the annular chamber so that the animal to enter or exit from the annular chamber. The housing is preferably formed from yarn or fabric and can be crocheted. Animals that prefer to relax on a coiled configuration can easily enter the housing and then coil into their preferred resting configuration once inside the annular chamber.

### CROSS-REFERENCE TO RELATED APPLICATIONS

The present application claims priority to U.S. Provisional App. No. 63/311,076, filed on Feb. 17, 2022.

### BACKGROUND OF THE INVENTION

### 1. Field of the Invention

The present invention relates to animal housings and, more specifically, to a comfortable device for housing snakes.

### 2. Description of the Related Art

Animals, including reptiles such as snakes, commonly prefer to rest in enclosed spaces including those that assist with maintaining an appropriate temperature for the relaxation of the animal. While there are several different types of housings for snakes, there are no housings that are specifically designed to accommodate the preference of a snake to form a coil and that can prevent the animal from easily escaping. Accordingly, there is a need in the art for a housing that is particularly welcoming for snakes and other animals that prefer to lounge in a coiled configuration and maintain them in that location.

### BRIEF SUMMARY OF THE INVENTION

The present invention provides a housing that is particularly well-adapted for animals that prefer to coil. The housing has a toroidal body defining an annular chamber therein. An opening is formed in the body and permits communication with the annular chamber so that the animal to enter or exit from the annular chamber. The housing is preferably formed from yarn or fabric and can be crocheted.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 a top plan of a housing according to the present invention.

FIG. 2 is a cross-sectional view of a housing showing the various dimensions that could be selected for a device according to the present invention.

FIG. 3 is a bottom plan a housing according to the present invention.

FIG. 4 is an illustration of a snake enjoying a housing according to the present invention.

### DETAILED DESCRIPTION OF THE INVENTION

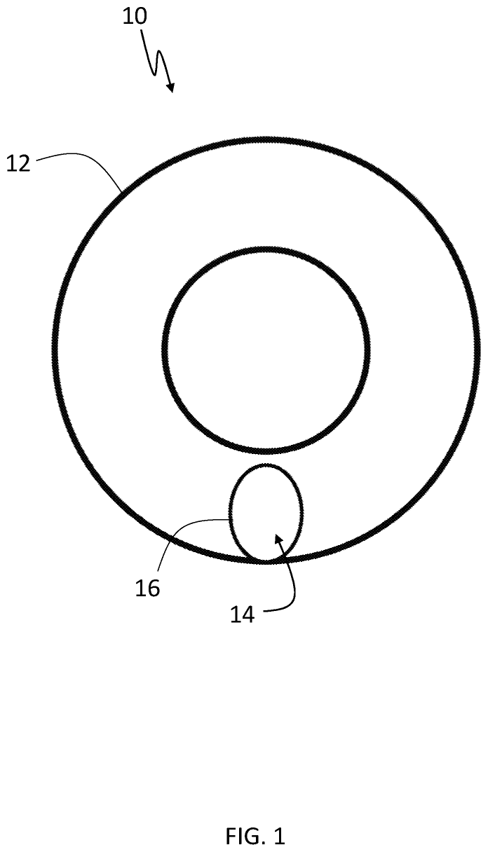

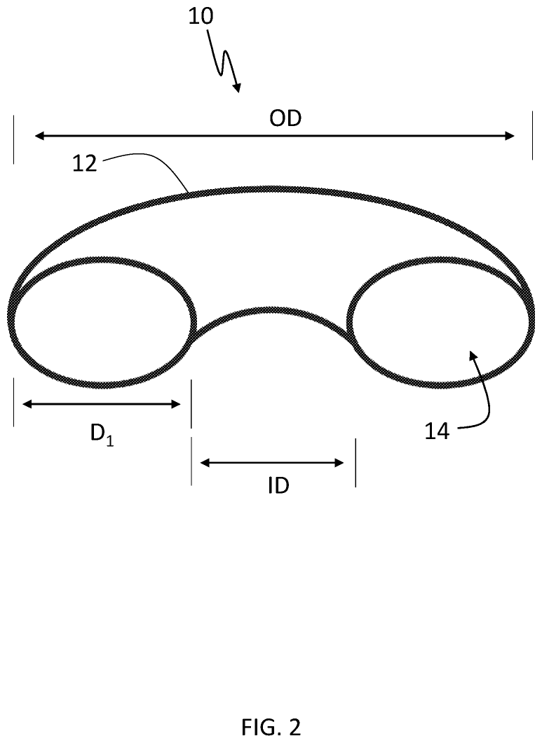

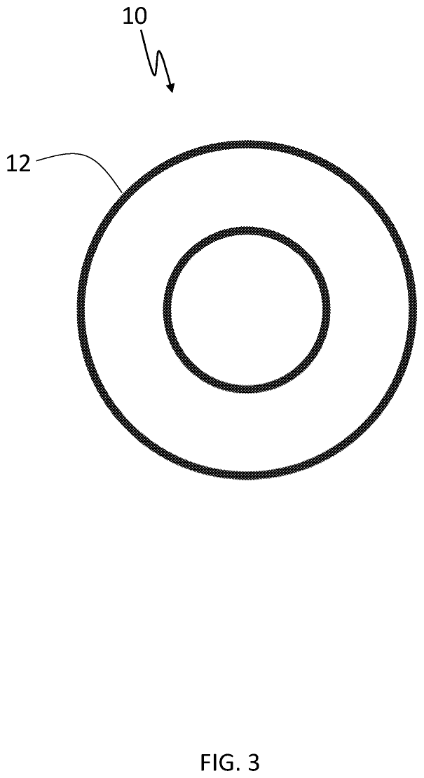

Referring to the figures, wherein like numerals refer to like parts throughout, there is seen in FIG. 1 a reptile housing 10 designed for housing a reptile and, more specifically a snake. Housing 10 comprises a body 12 formed as a toroidal ring having an outer diameter (OD), and inner diameter (ID), and an annular chamber 14 formed therein and having a diameter (Di), as detailed in FIG. 2. An opening 16 permits access to chamber 14 so that an animal can easily ingress and egress from chamber 14. A second opening 16 may be provided if desired. Annular chamber 14 of body 12 extends within body 14 and, as seen in FIG. 3, is only open to the environment at opening 1 seen in FIG. 1. Housing 10 can be dimensioned to accept any particularly sized animal. For example, as seen in FIG. 2, body 12 may have an outer diameter (OD) of between 6.5 and 16 inches to accommodate different sized animals, including snakes up to eight feet long, with proportional increases in the inner diameter (ID) as well as diameter Di of toroidal body 12. As should be understood by those of skill in the art, larger dimensions could be adopted for longer or larger animal.

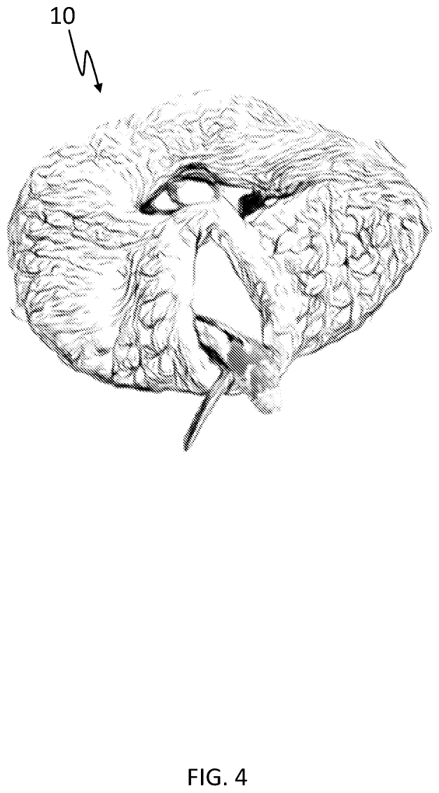

The ratio of the thickness of body 12 to the overall diameter of body 12 are subject to change and can be used in any proportion as desired. Housing 10 may be formed from yarn, fabric or any other material that is suitable for animals. As an example, a crochet pattern may be used to form housing 10. As seen in FIG. 4, housing 10 is particular suitable to animals such as snakes that can coil within chamber 14.

What is claimed is:

1. An animal housing device, comprising
a toroidal body defining an annular chamber therein; and
an opening formed in said toroidal body that is in communication with said annular chamber.

2. The animal housing device of claim 1, where said toroidal body has a diameter of between 6.5 and 16 inches.

3. The animal housing device of claim 2, further comprising a second opening formed in said toroidal body.

4. The animal housing device of claim 3, wherein said toroidal body is formed from a fabric.

5. The animal housing device of claim 3, wherein said toroidal body is formed from a woven material.

6. The animal housing device of claim 5, wherein said woven material comprises yarn.

7. The animal housing device of claim 5, wherein said woven material is formed in a crocheted pattern.

8. A method of providing housing for an animal, comprising the steps of:
providing a toroidal body defining an annular chamber therein; and
providing an opening formed in said toroidal body that is in communication with said annular chamber.

9. The method of claim 8, where said toroidal body has a diameter of between 6.5 and 16 inches.

10. The method of claim 9, further comprising a second opening formed in said toroidal body.

11. The method of claim 10, wherein said toroidal body is formed from a fabric.

12. The method of claim 10, wherein said toroidal body is formed from a woven material.

13. The method of claim 12, wherein said woven material comprises yarn.

14. The method of claim 13, wherein said woven material is formed in a crocheted pattern.
